(19) United States
(12) Patent Application Publication
(10) Pub. No.: US 2023/0253675 A1
(43) Pub. Date: Aug. 10, 2023

(54) MEMBRANE MADE OF A POLYCRYSTALLINE LLZO PRODUCT

(71) Applicant: SAINT-GOBAIN CENTRE DE RECHERCHES ET D'ETUDES EUROPEEN, COURBEVOIE (FR)

(72) Inventors: Costana Mihaela Ionica Bousquet, Cavaillon (FR); Sylvain PETIGNY, Velleron (FR); Vincent Benoît Ranieri, Cavaillon Cedex (FR)

(21) Appl. No.: 18/012,480

(22) PCT Filed: Jul. 6, 2021
(86) PCT No.: PCT/EP2021/068688

§ 371 Date: Dec. 22, 2022

(30) Foreign Application Priority Data
Jul. 9, 2020 (FR) FR2007268

(51) Int. Cl. H01M 50/431; H01M 10/0525; H01M 50/403

(52) U.S. Cl. CPC H01M 50/431; H01M 10/0525; H01M 50/403; H01M 2300/0071

(57) ABSTRACT

A fused solid-state electrolyte e membrane having a thickness less than 5 mm and intended for a lithium-ion battery. The membrane includes a polycrystalline product including at least 3.0% amorphous phase and including, for more than 95% of its mass, of the elements Li, La, Zr, M and O, M being a dopant chosen from the group formed by Al, P, Sb, Sc, Ti, V, Y, Nb, Hf, Ta, the lanthanides with the exception of La, Se, W, Bi, Si, Ge, Ga, Sn, Cr, Fe, Zn, Na, K, Rb, Cs, Fr, Mg, Ca, Sr, Ba and the mixtures thereof. The contents of these elements, measured after a decarbonatation operation without loss of lithium, being defined by the formula LiₐLa_{b}Zr_{c}M_{d}O₁₂, wherein the atomic indices are such that: 2.500<a<8,500, and 1,000<b<3.500, and 0.600<c<2.000, and 0<d<2.000.

### TECHNICAL FIELD

The invention relates to a solid-state electrolyte membrane made of an LLZO material, intended for a battery, in particular a lithium-ion battery. The invention also relates to such a battery.

The invention also relates to a method for manufacturing such a membrane.

### PRIOR ART

Conventionally, “lithium lanthanum zirconium oxide” or “LLZO” is used to denote garnets of the generic formula Li₇La₃Zr₂O₁₂, the electroneutrality being ensured by the oxygen content, the Li₇La₃Zr₂O₁₂ phase optionally being doped with a dopant M for the purpose of improving ionic conductivity and/or suitability for sintering. The dopant M may in particular be Al, P, Sb, Sc, Ti, V, Y, Nb, Hf, Ta, lanthanides excluding La, Se, W, Bi, Si, Ge, Ga, Sn, Cr, Fe, Zn, Na, K, Rb, Cs, Fr, Mg, Ca, Sr, Ba or a mixture of these elements.

LLZO can be found with two crystallographic lattices:
cubic phase, generally stable above 200° C. and exhibiting ionic conductivity;
tetragonal phase, stable at ambient temperature and having an ionic conductivity lower than that of the cubic phase.

A battery comprising a solid-state LLZO electrolyte membrane is known. Such a membrane is manufactured by sintering and has a substantially planar form, with a substantially constant thickness typically of about 400 microns. In this application, the highest possible ionic conductivity, and hence the greatest possible amount of cubic phase, is sought.

However, the membrane degrades rapidly when it is brought into contact with air.

In order to be stored, the membrane can be isolated in hermetic packaging, under argon, which increases production costs.

Lastly, the battery is conventionally assembled at least in part under air, and the degradation of the membrane in contact with the air can limit the performance thereof.

There is therefore a need for a solid-state LLZO electrolyte membrane that is conserved well when it is left in contact with air.

One object of the invention is to at least partially meet this need.

### SUMMARY OF THE INVENTION

According to the invention, this aim is met by means of a fused solid-state electrolyte membrane having a thickness of less than 5 mm and intended for a lithium-ion battery, the membrane consisting of a polycrystalline product comprising less than 3.0% of amorphous phase and consisting, for more than 95% of its mass, of the elements Li, La, Zr, M and O, M being a dopant chosen from the group formed by Al, P, Sb, Sc, Ti, V, Y, Nb, Hf, Ta, lanthanides excluding La, Se, W, Bi, Si, Ge, Ga, Sn, Cr, Fe, Zn, Na, K, Rb, Cs, Fr, Mg, Ca, Sr, Ba, and mixtures thereof, the contents of said elements, measured after an operation of decarbonation without loss of lithium, being defined by the formula LiₐLa_{b}Zr_{c}M_{d}O₁₂, in which the atomic indices are such that:
2.500≤a≤8.500, and
1.000≤b≤3.500, and
0.600≤c≤2.000, and
0<d≤2.000.

As will be seen in more detail in the description that follows, the resistance to ageing in air of a fused membrane according to the invention is markedly greater than that of sintered membranes.

Lastly, the manufacture of a fused polycrystalline product is a well-known technique. In a known manner, the cooling conditions are designed solely so that the amount of amorphous phase is small. The presence of a small amount of amorphous phase makes it possible to control the ionic conductivity well. In particular, this conductivity does not vary substantially from one sample to another.

Preferably, a membrane according to the invention also includes one, and preferably two or more, of the following optional features:
at least one of the major faces of the membrane has a roughness Ra of less than 500 nm;
the total amount by mass of cubic LLZO and tetragonal LLZO phases is greater than 80.0%, in percentages by mass based on the mass of the crystalline phases, “LLZO” denoting a lithium lanthanum zirconium oxide of the generic formula Li₇La₃Zr₂O₁₂;
the total amount by mass of cubic LLZO and tetragonal LLZO phases is greater than 90.0%, preferably greater than 99.0%, in percentages by mass based on the mass of the crystalline phases;
the cubic LLZO phase represents more than 35% of all of the cubic LLZO and tetragonal LLZO phases together, in percentages by mass;
in the formula LiₐLa_{b}Zr_{c}M_{d}O₁₂,
a is greater than 2.800 and less than 8.300; and/or
b is greater than 1.100 and less than 3.300; and/or
c is greater than 0.600 and less than 1.900; and/or
d is greater than 0.010 and less than 1.900;
preferably
a is greater than 4.500 and less than 8.000; and/or
b is greater than 2.000 and less than 3.100; and/or
c is greater than 1.000 and less than 1.900; and/or
d is greater than 0.100 and less than 1.000;
preferably
a is greater than 6.000 and less than 7.000; and/or
b is greater than 2.500 and less than 2.900; and/or
c is greater than 1.400; and/or
d is greater than 0.200 and less than 0.400;
the crystalline phases not containing lithium represent, in total, less than 3% of the mass of the crystalline phases;
the polycrystalline product comprises less than 1.0% of amorphous phase and/or has a relative skeletal density of greater than 90%;
the polycrystalline product has a microstructure composed for more than 90% by number of grains having an elongation factor of greater than 2.5, referred to as “elongated grains”;
said elongated grains are substantially parallel to one another;
preferably
   M comprises the element Y, the atomic index of element Y is greater than 0.005 and less than 0.300, and the sum of the atomic indices of elements M other than the element Y is less than 0.300; or
   M comprises the element Ce, and the atomic index of said element Ce is less than 0.300; or
   M comprises the elements Ti and/or Fe, and the sum of the atomic indices of Ti and Fe is less than 0.800; or
   M comprises the element Al, the atomic index of element Al is greater than 0.005 and less than 1.300, and the sum of the atomic indices of elements M other than aluminum is less than 0.300; or
   M comprises the elements Ta and/or Nb and/or V, the sum of the atomic indices of elements Ta, Nb and V is greater than 0.010 and less than 1.000, and the sum of the atomic indices of elements M other than the elements Ta, Nb and V is less than 0.300; or
   M comprises the element Ta and the atomic index of element Ta is greater than 0.050 and less than 0.900, and the sum of the atomic indices of elements M other than the element Ta is less than 0.300; or
   M comprises the elements Sr and/or Ba and/or Ca and/or Mg, the sum of the atomic indices of elements Sr, Ba, Ca and Mg is greater than 0.005, and the sum of the atomic indices of elements M other than the elements Sr, Ba, Ca and Mg is less than 0.300; or
   M comprises the elements Na and/or K, the sum of the atomic indices of elements Na and K is greater than 0.005, and the sum of the atomic indices of elements M other than the elements Na and K is less than 0.300;
more preferably
   M comprises the element Y, the atomic index of element Y is greater than 0.005 and less than 0.200, and the sum of the atomic indices of elements M other than the element Y is less than 0.100; or
   M comprises the element Ce, and the atomic index of said element Ce is less than 0.200; or
   M comprises the elements Ti and/or Fe, and the sum of the atomic indices of Ti and Fe is less than 0.600; or
   M comprises the element Al, the atomic index of element Al is greater than 0.150 and less than 0.700, and the sum of the atomic indices of elements M other than aluminum is less than 0.100; or
   M comprises the elements Ta and/or Nb and/or V, the sum of the atomic indices of elements Ta, Nb and V is greater than 0.300 and less than 0.700, and the sum of the atomic indices of elements M other than the elements Ta, Nb and V is less than 0.100; or
   M comprises the elements Sr and/or Ba and/or Ca and/or Mg, the sum of the atomic indices of elements Sr, Ba, Ca and Mg is greater than 0.100, and the sum of the atomic indices of elements M other than the elements Sr, Ba, Ca and Mg is less than 0.100; or
   M comprises the elements Na and/or K, the sum of the atomic indices of elements Na and K is greater than 0.100, and the sum of the atomic indices of elements M other than the elements Na and K is less than 0.100.

The invention also relates to a method for manufacturing a membrane according to the invention, said method comprising the following steps:
a) mixing starting materials so as to form a starting feedstock suitable for obtaining, on conclusion of step c), a said polycrystalline product,
b) melting the starting feedstock until a liquid mass is obtained,
c) cooling until said liquid mass has completely solidified, the cooling preferably being carried out at a rate of greater than 200° C./s,
d) polishing the polycrystalline product obtained on conclusion of step c) so as to obtain a fused membrane according to the invention.

Preferably, step c) comprises the following steps:
c1″) casting the liquid mass, in the form of a jet, between two rollers;
c2″) solidifying by cooling the cast liquid mass in contact with the rollers until an at least partially solidified block of polycrystalline product is obtained.

The invention lastly relates to a lithium-ion battery comprising a fused membrane according to the invention, preferably manufactured according to a method according to the invention, disposed between an anode and a cathode of said battery.

### Definitions

The term “fused membrane” refers to a membrane made of a material directly obtained by melting a starting feedstock, in the form of a liquid mass, and then solidifying said liquid mass. The term “directly obtained” is understood to mean that the material is obtained immediately after said solidification. Such a process differs in particular from a molten salt synthesis. Preferably, the melting is above 1200° C.

A membrane made of a sintered material is not a “fused membrane”, even if the grains agglomerated by sintering are fused grains.

A “polycrystalline” material refers to a solid material made up of a multitude of crystallites of varying size and orientation, as opposed to a monocrystalline material consisting of a single crystal. The polycrystalline character of a material may for example be demonstrated with the aid of scanning electron microscope observations making it possible to reveal grain boundaries and/or by Raman spectroscopy. Unless particular precautions are taken, a fused product is polycrystalline.

The “relative skeletal density” of a product corresponds to the ratio equal to the skeletal density of said product divided by the absolute density of said product, expressed as a percentage.

The term “skeletal density” of a product is understood to mean the ratio equal to the mass of said product divided by the skeletal volume that it occupies. The skeletal volume of the product corresponds to the sum of the volumes of the material and of the closed pores, said skeletal volume being determined on a membrane or a plate by helium pycnometry.

The term “absolute density” of a product is understood to mean the ratio equal to the mass of dry matter of said product after grinding to a fineness such that substantially no closed porosity remains, divided by the volume of said mass of dry matter after grinding, it being possible to determine said volume by helium pycnometry.

An operation of “decarbonation without loss of lithium” is a conventional operation during which a material is heated so as to remove the carbonates from it without extracting the lithium from it. For example, the material can be heated under the conditions described in the examples.

“Lanthanides” refers to the elements of the periodic table from atomic number 58 (cerium) up to atomic number 71 (lutetium).

A “precursor” of a compound or of an element is understood to mean a constituent capable of providing said compound or element, respectively, when a manufacturing method according to the invention is carried out.

Unless otherwise indicated, and in particular in the formula LiₐLa_{b}Zr_{c}M_{d}O₁₂ in which the indices a, b, c, d and 12 are atomic indices, all contents of the constituents according to the invention are percentages by mass expressed on the basis of the product.

The terms “containing”, “comprising” or “including” should be interpreted broadly, unless indicated otherwise.

### DETAILED DESCRIPTION

### Membrane

A solid-state electrolyte membrane according to the invention is intended for a lithium-ion battery. Its dimensions are adapted for this purpose.

Conventionally, such a membrane has the general form of a thin plate of substantially constant thickness and of which at least one of the two faces (or “major faces”), preferably both faces, are polished.

The thickness of the membrane is less than 5 mm, preferably less than 4 mm, preferably less than 3 mm, preferably less than 2 mm, preferably less than 1 mm, preferably less than 800 μm, preferably less than 600 μm, preferably less than 400 μm, and/or preferably greater than 40 μm, preferably greater than 50 μm, preferably greater than 100 μm, preferably greater than 150 μm.

In one embodiment, the thickness of the membrane is greater than 600 μm, preferably greater than 800 μm, or even greater than 1 mm

The length and width are adapted to the battery. Typically, the length and/or width are greater than 1 mm, preferably greater than 2 mm, preferably greater than 5 mm, or even greater than 10 mm, and/or preferably less than 300 mm, or even less than 200 mm, or even less than 100 mm

The membrane may in particular take the form of a rectangular plate or of a disk.

The roughness Ra of at least one of the major faces of the membrane, preferably of both major faces of the membrane, measured in accordance with the standard ISO 4287:1997, is typically less than 500 nm, preferably less than 400 nm, preferably less than 300 nm, preferably less than 200 nm, preferably less than 100 nm, preferably less than 50 nm, preferably less than 40 nm, or even less than 30 nm.

Until the present invention, LLZO membranes were made of a sintered material. A membrane according to the invention is “fused”. The membrane is therefore not an agglomerate of particles, but the result of shaping a block obtained by cooling a liquid mass. The microstructure of the polycrystalline product which constitutes a membrane according to the invention is thus specific.

### Microstructure

The percentage of amorphous phase in the polycrystalline product is particularly small and cannot be precisely determined with conventional methods such as X-ray diffraction. Preferably, to evaluate an amorphous phase content that is not very high, a surface area percentage is evaluated, where this can be measured as described in the examples.

Preferably, the amorphous phase content, expressed in surface area percentages, is less than 3.0%, less than 2.5%, preferably less than 2.0%, preferably less than 1.5%, preferably less than 1.0%, or even less than 0.5%, or even substantially zero.

Advantageously, a low content of amorphous phase limits variations in ionic conductivity from one sample of the polycrystalline product to another.

Preferably, the total amount by mass of the oxides containing lithium, of the hydroxide phases containing lithium and of the carbonate phases containing lithium is greater than 95.0%, preferably greater than 96.0%, preferably greater than 97.0%, preferably greater than 98.0%, preferably greater than 99.0%.

In other words, the total amount by mass of the phases which are not oxides, hydroxides or carbonates comprising lithium is preferably less than 5%, preferably less than 4%, preferably less than 3%, preferably less than 2%, preferably less than 1%, in percentages by mass based on the crystalline phases.

Preferably, the total amount by mass of cubic LLZO and tetragonal LLZO phases is greater than 80.0%, preferably greater than 90.0%, preferably greater than 92.0%, preferably greater than 94.0%, preferably greater than 95.0%, preferably greater than 96.0%, preferably greater than 97.0%, preferably greater than 98.0%, preferably greater than 99.0%, or even greater than 99.5%, in percentages by mass based on the mass of the crystalline phases.

Preferably, the cubic LLZO phase represents more than 35%, preferably more than 40%, preferably more than 45%, preferably more than 50%, preferably more than 60%, preferably more than 70%, preferably more than 80%, preferably more than 90%, preferably more than 95% of all of the cubic LLZO and tetragonal LLZO phases together, in percentages by mass.

More preferably, the oxide phases containing lithium other than the LLZO phases, the hydroxide phases containing lithium and the carbonate phases containing lithium altogether represent more than 95% of the crystalline phases containing lithium other than the LLZO phases.

The oxide phases containing lithium other than the LLZO phases, the hydroxide phases containing lithium and the carbonate phases containing lithium are preferably chosen from Li₂O, LiOH, Li₂CO₃ and mixtures thereof, preferably Li₂CO₃.

The crystalline phases not containing lithium preferably represent, in total, less than 5%, preferably less than 3%, preferably less than 2%, preferably less than 1%, in percentages by mass based on the crystalline phases.

The content and the nature of the LLZO obtained depend in particular on the composition of the starting feedstock. The closer the chemical composition of the starting feedstock is to that of the desired LLZO, the greater is the amount of said LLZO in the polycrystalline product.

In one embodiment, the polycrystalline product has a microstructure composed for more than 90% by number of grains having an elongation factor of less than 1.6, preferably of less than 1.4, preferably of less than 1.25, or even of less than 1.20, the elongation factor being equal to the greatest dimension of the grain to the smallest dimension of said grain, measured perpendicularly to the greatest dimension of the grain, on a sectional view of the polycrystalline product. When the grains of the product have a preferred orientation, the section is made parallel to said preferred direction. In particular, when the liquid mass of molten material has been cooled by contact with a cold plate, the section should be made perpendicularly to said plate. The preferred orientation of the grains is the direction of the length of the majority of grains.

Preferably, the polycrystalline product has a mean grain size of greater than 10 μm, preferably of greater than 20 μm, preferably of greater than 30 μm, preferably of greater than 40 μm, preferably of greater than 50 μm, or even of greater than 60 μm, or even of greater than 70 μm, and/or preferably of less than 500 μm, preferably of less than 450 μm, preferably of less than 400 μm, preferably of less than 350 μm, preferably of less than 300 μm, or even of less than 250 μm, said mean size being measured by a “Mean Linear Intercept” method. A measurement method of this type is described in the standard ASTM E1382.

In one embodiment, the polycrystalline product has a microstructure composed for more than 10%, or even for more than 20%, or even for more than 30%, or even for more than 40%, or even for more than 50%, or even for more than 60%, or even for more than 70%, or even for more than 80%, or even for more than 90%, or even for more than 95%, or even for more than 99%, by number, of elongated grains, preferably having an elongation factor of greater than 3, or even of greater than 4, or even of greater than 5.

### Composition

Preferably, in the formula LiₐLa_{b}Zr_{c}M_{d}O₁₂,
a is greater than 2.800, preferably greater than 3.000, preferably greater than 3.500, preferably greater than 4.000, preferably greater than 4.500, preferably greater than 4.800, preferably greater than 5.000, or even greater than 5.500, or even greater than 6.000, and/or less than 8.300, preferably less than 8.000, preferably less than 7.500, preferably less than 7.000; and/or
b is greater than 1.100, preferably greater than 1.200, preferably greater than 1.300, or even greater than 1.500, or even greater than 1.800, or even greater than 2.000, or even greater than 2.200, or even greater than 2.400, or even greater than 2.500, and/or less than 3.300, preferably less than 3.100, preferably less than 3.000, preferably less than 2.900; and/or
c is greater than 0.600, preferably greater than 0.700, preferably greater than 0.800, or even greater than 0.900, or even greater than 1.000, or even greater than 1.200, or even greater than 1.400, and/or less than 1.900; and/or
d is greater than 0.010, preferably greater than 0.050, or even greater than 0.100, or even greater than 0.200, and/or less than 1.900, preferably less than 1.800, preferably less than 1.700, preferably less than 1.500, preferably less than 1.300, preferably less than 1.200, preferably less than 1.100, preferably less than 1.000, preferably less than 0.900, preferably less than 0.800, preferably less than 0.700, preferably less than 0.600, or even less than 0.500, or even less than 0.400.

Preferably, the composition of the polycrystalline product meets more than one of the above preferred conditions relating to the atomic indices a, b, c and d.

M may be introduced into the starting feedstock to be fused as traces in a starting material. The atomic index d takes these additions into account.

M is preferably chosen from the group formed by Al, Sb, V, Y, Nb, Hf, Ta, Ce, Si, Na, K, Mg, Ca, Sr, Ba and mixtures thereof, preferably from the group formed by Al, V, Y, Nb, Hf, Ta, Si, Na, Mg, Ca, Sr and mixtures thereof.

In a particular embodiment, M comprises the element Y, the atomic index of said element Y being less than 0.300, preferably less than 0.200, and greater than 0.005, preferably greater than 0.010.

In a particular embodiment, M comprises the element Ce, the atomic index of said element Ce being less than 0.800, preferably less than 0.600, preferably less than 0.400, preferably less than 0.300, or even less than 0.200 and/or greater than 0.005, preferably greater than 0.010, or even greater than 0.050, or even greater than 0.100.

In a particular embodiment, M comprises Ti and/or Fe, the sum of the atomic indices of Ti and/or Fe being less than 0.800, preferably less than 0.700, preferably less than 0.600 and/or greater than 0.005, preferably greater than 0.010, or even greater than 0.050, or even greater than 0.100, or even greater than 0.200, or even greater than 0.300.

In a particular embodiment, the polycrystalline product is such that:
the atomic index of element Al is greater than 0.005, preferably greater than 0.010, preferably greater than 0.050, preferably greater than 0.100, preferably greater than 0.150, and/or preferably less than 1.300, preferably less than 1.200, preferably less than 1 100, preferably less than 1.000, preferably less than 0.900, preferably less than 0 800, preferably less than 0.700, preferably less than 0.600, and
the sum of the atomic indices of elements M other than aluminium is less than 0.300, preferably less than 0.200, preferably less than 0.100.

In a particular embodiment, the polycrystalline product is such that:
the sum of the atomic indices of elements tantalum, niobium and vanadium is greater than 0.010, preferably greater than 0.050, or even greater than 0.100, or even greater than 0.200, or even greater than 0.300, and/or, preferably, less than 1.000, preferably less than 0.900, preferably less than 0.800, preferably less than 0.700, and
the sum of the atomic indices of elements M other than the elements tantalum, niobium and vanadium is less than 0.300, preferably less than 0.200, preferably less than 0 100.

In a particular preferred embodiment, the polycrystalline product is such that:
the atomic index of element tantalum is greater than 0.010, preferably greater than 0.050, or even greater than 0.100, or even greater than 0.200, or even greater than 0.300, and/or, preferably, less than 1.000, preferably less than 0.900, preferably less than 0.800, preferably less than 0.700, and
the sum of the atomic indices of elements M other than the element tantalum is less than 0.300, preferably less than 0.200, preferably less than 0.100.

In a particular embodiment, the polycrystalline product is such that:
the atomic index of element yttrium is greater than 0.005, preferably greater than 0.010, and/or preferably less than 0.300, preferably less than 0.200, and
the sum of the atomic indices of elements M other than the element yttrium is less than 0.300, preferably less than 0.200, preferably less than 0.100.

In a particular embodiment, the polycrystalline product is such that:
the sum of the atomic indices of elements strontium, barium, calcium and magnesium is greater than 0.005, preferably greater than 0.010, preferably greater than 0.050, or even greater than 0.100, and/or preferably less than 1.500, preferably less than 1.300, preferably less than 1.000, and
the sum of the atomic indices of elements M other than the elements strontium, barium, calcium and magnesium is less than 0.300, preferably less than 0.200, preferably less than 0.100.

In a particular embodiment, the polycrystalline product is such that:
the sum of the atomic indices of elements sodium and potassium is greater than 0.005, preferably greater than 0.010, preferably greater than 0.050, preferably greater than 0.100, and/or preferably less than 1.500, preferably less than 1.300, preferably less than 1.000, and
the sum of the atomic indices of elements M other than the elements sodium and potassium is less than 0.300, preferably less than 0.200, preferably less than 0.100.

Preferably, the amount by mass of elements other than Li, La, Zr, M and O is less than 4.0%, preferably less than 3.0%, preferably less than 2.0%, preferably less than 1.5%, preferably less than 1.0%, preferably less than 0.5%. Preferably, the elements other than Li, La, Zr, M and O are inevitable constituents introduced unintentionally and unavoidably with the starting materials.

### Properties

The relative skeletal density of the polycrystalline product is preferably greater than 85%, preferably greater than 88%, preferably greater than 90%, preferably greater than 92%, preferably greater than 94%, preferably greater than 95%, preferably greater than 96%, preferably greater than 97%, preferably greater than 98%, preferably greater than 98.5%, preferably greater than 99%, preferably greater than 99.5%, preferably greater than 99.8%.

Advantageously, the ionic conductivity is thereby improved.

### Method

The invention also relates to a manufacturing method comprising steps a) to d).

Advantageously, a method according to the invention makes it possible to obtain high relative densities. In addition, it avoids a step of forming a powder and then sintering.

In step a), a starting feedstock enabling the manufacture of a membrane according to the invention is formed from compounds of lithium, of lanthanum, of zirconium and optionally of element M, in particular in the form of oxides and/or carbonates and/or hydroxides and/or oxalates and/or nitrates, and/or precursors of the elements lithium, lanthanum, zirconium and M. The composition of the starting feedstock can be adjusted by adding pure oxides or mixtures of oxides and/or precursors, in particular Li₂O, Li₂CO₃, LiOH, La₂O₃, ZrO₂, a lanthanum carbonate, a zirconium hydrate, oxide(s) of the element M, carbonate(s) of the element M, hydroxide(s) of the element M. The use of oxides and/or carbonates and/or hydroxides and/or nitrates and/or oxalates improves the availability of oxygen required for the formation of the LiₐLa_{b}Zr_{c}M_{d}O₁₂ phase and for the electroneutrality thereof, and is therefore preferred.

Preferably, at least one, and even all, the elements lanthanum, zirconium and M are introduced into the starting feedstock in the form of oxides. In a particular embodiment, oxide powders are used to supply the elements lanthanum, zirconium and M, and a carbonate powder is used for supplying the element lithium.

Preferably, the compounds supplying the elements lithium, lanthanum, zirconium and M are chosen from Li₂CO₃, Li₂O, LiOH, La₂O₃, ZrO₂, carbonates of the element M, hydroxides of the element M, and oxides of the element M.

Preferably, the compounds supplying the elements lithium, lanthanum, zirconium and M altogether represent more than 90%, preferably more than 99%, in percentages by mass, of the constituents of the starting feedstock. Preferably, these compounds represent, together with the impurities, 100% of the constituents of the starting feedstock.

Preferably, no compound other than those supplying the elements lithium, lanthanum, zirconium and M, indeed even no compound other than Li₂CO₃, Li₂O, LiOH, La₂O₃, ZrO₂, carbonates of the element M, hydroxides of the element M, and oxides of the element M, is intentionally introduced into the starting feedstock. In one embodiment, the sum of Li₂CO₃, Li₂O, LiOH, La₂O₃, ZrO₂, carbonates of the element M, hydroxides of the element M, and oxides of the element M represents more than 99% by mass of the starting feedstock.

The amounts of lithium, lanthanum, zirconium and element M in the starting feedstock can for the most part be found in the polycrystalline product manufactured. A portion of the elements, such as for example lithium, which can vary depending on the melting conditions, may volatilize during the melting step. Those skilled in the art, through their general knowledge or by simple routine tests, knows how to adjust the amount of these elements in the starting feedstock depending on the content that they wish to find in the fused products and on the melting conditions employed.

The particle sizes of the powders used may be those commonly encountered in melting processes.

Intimate mixing of the starting materials may be carried out in a mixer. This mixture is then poured into a melting furnace.

In step b), the starting feedstock is melted.

All known furnaces can be envisaged, such as an induction furnace, a plasma furnace or other types of Héroult furnace, provided that they make it possible to completely melt the starting feedstock. Crucible melting in a heat treatment furnace, preferably in an electric furnace, preferably in an oxygenated environment, for example under air, can also be envisaged. Electric melting advantageously makes it possible to manufacture large amounts of polycrystalline product with advantageous yields.

For example, use may be made of a Héroult-type arc furnace comprising two electrodes and having a vessel with a diameter of approximately 0.8 m that can contain approximately 180 kg of molten liquid.

In step b), the energy provided is preferably greater than 1100 kWh/T of starting feedstock, preferably greater than 1200 kWh/T. Preferably, the energy provided is between 1200 kWh/T and 1800 kWh/T, preferably between 1300 kWh/T and 1600 kWh/T. The voltage is for example 130 volts and the power is 200 kW.

An induction furnace may also advantageously be used.

After melting, the starting feedstock is in the form of a liquid mass, which may optionally contain some solid particles, but in an amount that is insufficient to give structure to said mass. By definition, to retain its shape, a liquid mass has to be kept in a container.

The general environment of the liquid mass can be neutral, reducing or oxidizing, preferably oxidizing, and can preferably be air.

The temperature of the molten liquid, for example measured from the thin stream of said molten liquid before step c), is preferably greater than the melting point of the polycrystalline product, preferably greater than 1200° C., or even greater than 1250° C., or even greater than 1300° C., and preferably less than 1650° C., preferably less than 1600° C., preferably less than 1550° C., preferably less than 1500° C.

In step c), the cooling rate is preferably greater than 50° C./s, preferably greater than 100° C./s, preferably greater than 200° C./s.

In one embodiment, the cooling rate is greater than 200° C./s and preferably less than 10 000° C./s, preferably less than 1 000° C./s, preferably less than 800° C./s, preferably less than 600° C./s.

Advantageously, a high cooling rate makes it possible to increase the amount by mass of cubic LLZO phase, based on the mass of crystalline phases. A high cooling rate also makes it possible, advantageously, to reduce the amount of amorphous phase.

Lastly, a high cooling rate makes it possible to create a temperature gradient enabling the creation of a microstructure having a large amount of elongated grains oriented along the direction of the greatest temperature gradient. In particular, cooling by contact with a cooled plate makes it possible to orient the elongated grains substantially perpendicularly to the plate.

The anisotropy may decrease with increasing distance of the region under consideration from the cooled plate.

In a preferred embodiment, the anisotropy results from the passage of the liquid mass between two rollers that are themselves cooled.

In one embodiment, step c) comprises the following steps:
c1′) casting the liquid mass into a mold;
c2′) solidifying, by cooling, the liquid mass cast into the mold until an at least partially solidified block is obtained;
c3′) removing the block from the mold.

In step c1′), the liquid mass is cast into a mold capable of withstanding the bath of molten liquid. Preferably, molds made of graphite or cast iron are used. Molds are also described in U.S. Pat. No. 3,993,119. In the case of an induction furnace, the coil is considered to constitute a mold. Casting is preferably carried out under air.

In step c2′), the liquid mass cast into the mold is cooled until an at least partially solidified block is obtained. The use of a mold of the type of those described in U.S. Pat. No. 3,993,119 advantageously makes it possible to obtain a high amount by mass of cubic LLZO phase, based on the mass of the crystalline phases.

In step c3′), the block is removed from the mold. Preferably, the block is removed from the mold as soon as it has sufficient rigidity to substantially retain its shape.

Preferably, in step c1′) and/or in step c2′) and/or after step c3′), said liquid mass in the course of solidification is brought, directly or indirectly, into contact with an oxygenated fluid, preferably comprising more than 20% by volume of oxygen, preferably a gas, preferably air. This contacting can be carried out as soon as the casting is carried out.

In order to facilitate the contacting of the liquid mass with the oxygenated fluid, it is preferable to remove the block from the mold as rapidly as possible, if possible before complete solidification, and to then immediately commence the contacting with the oxygenated fluid. Thus, the solidification then continues in step c3′).

Preferably, contact with the oxygenated fluid is maintained until the block has completely solidified.

After complete solidification, a block is obtained that is capable of giving, after step d), a membrane the thickness of which is less than 5 mm, preferably less than 4 mm, preferably less than 3 mm, preferably less than 2 mm, preferably less than 1 mm, preferably less than 800 μm, preferably less than 600 μm, preferably less than 400 μm, and preferably greater than 40 μm, preferably greater than 50 μm, preferably greater than 100 μm, preferably greater than 150 μm. In a preferred embodiment, step c) comprises the following steps:
c1″) casting the liquid mass, in the form of a jet, between two rollers, both rollers preferably rotating and being cooled;
c2″) solidifying by cooling the cast liquid mass in contact with the rollers until an at least partially solidified block is obtained.

In step c1″), the liquid mass is cast in the form of a jet between two rollers able to withstand the molten liquid, so as to roll the jet of molten liquid. Preferably, the rollers are made of steel. They are preferably driven in counter rotation so as to roll the jet of liquid. Said rollers are preferably cooled, preferably with the aid of a circulation of fluid, preferably a liquid, preferably water, preferably without said liquid coming into contact with the jet of molten liquid.

In step c2″), the jet of liquid cast between the rollers is cooled until an at least partially solidified block is obtained. The use of such a method advantageously makes it possible to obtain, after complete solidification, a plate having a high relative skeletal density and a low thickness, which, after step d), makes it possible to obtain a membrane suitable for lithium-ion batteries.

Preferably, in step c1″) and/or in step c2″), said liquid mass in the course of solidification is brought, directly or indirectly, into contact with an oxygenated fluid, preferably comprising more than 20% by volume of oxygen, preferably a gas, preferably air.

Preferably, contact with the oxygenated fluid is maintained until the block has completely solidified.

Under the effect of the melting and then cooling, the elements Li, La, Zr, M and O combine in the form of cubic LLZO phase, tetragonal LLZO phase, indeed even other phases containing lithium (and in particular other oxide phases containing lithium, hydroxide phases containing lithium, and carbonate phases containing lithium) and/or phases not containing lithium.

In step d), the polycrystalline product obtained on conclusion of step c) is polished so as to reduce its roughness.

A fused membrane according to the invention is thus obtained.

Preferably, the polishing is carried out on at least one, preferably each, of the two major faces of the membrane.

Preferably, after polishing, the roughness Ra of at least one of the major faces of the membrane, preferably of each of the two major faces of the membrane is less than 500 nm, preferably less than 400 nm, preferably less than 300 nm, preferably less than 200 nm, preferably less than 100 nm, preferably less than 50 nm, preferably less than 40 nm, or even less than 30 nm.

In one embodiment, in step d), the thickness of the polycrystalline product obtained on conclusion of step c) is reduced, preferably until a thickness is obtained of less than 5 mm, preferably less than 4 mm, preferably less than 3 mm, preferably less than 2 mm, preferably less than 1 mm, preferably less than 800 μm, preferably less than 600 μm, preferably less than 400 μm, and preferably of greater than 40 μm, preferably greater than 50 μm, preferably greater than 100 μm, preferably greater than 150 μm.

This reduction may result in whole or in part from the polishing operation.

In a preferred embodiment, the thickness of the polycrystalline product is limited starting from the melting, in particular during a step c1″).

In one embodiment, machining makes it possible to reduce the length and/or the width of the polycrystalline product obtained on conclusion of step c).

The final length of the membrane obtained is preferably greater than 1 mm and less than 300 mm, typically between 10 mm and 100 mm The final width of the membrane is preferably greater than 1 mm and less than 300 mm, typically between 10 mm and 100 mm.

In one embodiment, the polycrystalline product and/or the membrane are cut so as to retain only the regions having a high amount of elongated grains.

Preferably, immediately before or after step d), preferably after step d), the membrane is dried, preferably at a temperature of greater than 90° C., preferably of greater than 100° C., and/or preferably of less than 200° C., preferably of less than 150° C., the hold time at this temperature preferably being greater than 5 hours, preferably greater than 10 hours, preferably greater than 20 hours, or even greater than 50 hours, and/or preferably less than 200 hours, preferably less than 100 hours.

### Examples

### Characterization Methods

The characterization methods below, described within the context of examples, can also be used to characterize the invention more generally.

The Chemical Analysis is Determined with the Aid of the Following Method:

Before analysis, the samples are preferably stored under vacuum or in a neutral atmosphere, for example under argon, in order to avoid carbonation.

The samples to be characterized are then ground in the dry state in an RS 100 mill sold by Retsch, equipped with a bowl and a tungsten carbide wheel, so as to have a maximum size of less than 160 μm (that is to say that more than 99.5% by mass of the particles of the ground powder have a size of less than 160 microns).

In the two hours following the end of grinding, the carbon content of the powder obtained is determined by instrumental gas analysis, for example using an EMIA-820V carbon/sulfur analyzer from HORIBA Scientific.

If the carbon content is less than 0.3%, dissolution by hydrochloric acid attack is carried out and the content of the various elements is determined by inductively coupled plasma spectrometry or ICP-AES.

If the carbon content is greater than 0.3%, the powder is placed into a magnesia crucible. The crucible is placed into an electric furnace and then brought to 950° C. and held at this temperature for 15 minutes. After cooling, the heat-treated powder is dissolved by hydrochloric acid attack and the content of the various elements is determined by inductively coupled plasma spectrometry or ICP-AES.

### The Nature and Amount of Crystalline Phases are Determined by the Following Conventional Method:

The samples to be characterized are ground in the dry state in an RS 100 mill sold by Retsch, equipped with a bowl and a tungsten carbide wheel, such that they are in the form of a powder having an oversize at 40 μm of less than 5% by mass.

A D8 Endeavor machine from Bruker is used for the acquisitions, over a 20 angular range of between 5° and 80°, with a step of 0.01°, and a count time of 0.68 s/step. The front lens comprises a primary slit of 0.3° and a Soller slit of 2.5°. The sample is rotated on itself at a speed equal to 15 rpm, with use of the automatic knife. The rear lens comprises a Soller slit of 2.5°, a 0.0125 mm nickel filter and a 1D detector with an aperture equal to 4°.

The diffraction diagrams are then analyzed qualitatively using the EVA software and the ICDD2016 database.

Record 182312 of the ICSD database makes it possible to identify the cubic Li₇La₃Zr₂O₁₂ phase and record 246816 of the ICSD database makes it possible to identify the tetragonal Li₇La₃Zr₂O₁₂ phase.

The phases revealed, in particular the cubic and tetragonal LLZO phases, may exhibit a slight shift in the peaks compared to the data records used. In particular, the tetragonal LLZO phase, which is optionally doped, is in general less distorted than the tetragonal Li₇La₃Zr₂O₁₂ phase of the ICSD database record, and the characteristic peaks of said phase nay be positioned at smaller 20 diffraction angles than those indicated in the ICSD database record.

When the secondary phases are identified, they are preferably crystalline phases of the group formed by orthorhombic La₂Zr₂O₇ (ICDD record −01-070-5602), orthorhombic LiLaO₂ (ICDD record 00-019-0722), monoclinic Li₂ZrO₃ (ICDD record 01-070-8744), monoclinic Li₂CO₃ (ICDD record 01-087-0728), hexagonal La₂O₃ (ICDD record 01-071-5408), monoclinic ZrO₂ (ICDD record 00-37-1484), and mixtures thereof.

Once the phases present are revealed, the measurement of the amount by mass of cubic and tetragonal LLZO phases as well as other crystalline phases is carried out by Rietveld refinement using the HighScore Plus software.

Before starting the refinement, it is necessary to check that the width of the base of the peaks (“profile base width”) is at least equal to 20.

The Rietveld refinement should be carried out in manual mode according to the following strategy, the transition from one step to the next only taking place after it has been ensured that the refinement has converged:
refinement of the background signal with the Chebyshev I function. Refinement of the zero, of the “flat background” and “1/x” parameters and of the 6 different coefficients. All of these parameters can be released at the same time, and then
simultaneous refinement of the scale factor of the different phases, and then
simultaneous refinement of the lattice parameters and of the profile parameter W of the cubic LLZO phase and of the tetragonal LLZO phase, the lattice parameters a, b and c of the tetragonal LLZO phase obligatorily being constrained such that the lattice remains tetragonal during the refinement, and then
refinement of the profile parameters U and then V of the cubic LLZO or tetragonal LLZO phase present in the greatest amount, and then
refinement of the “peak shape 1” shape parameter of the cubic LLZO or tetragonal LLZO phase only if just one of these two phases is present, and then
refinement of the profile parameters U and then V of the cubic LLZO or tetragonal LLZO phase present in the smallest amount, and then
simultaneous refinement of the lattice parameters of the other identified phases, and then
simultaneous refinement of the profile parameter W of the other identified phases, and then
refinement of the profile parameters U and V and “peak shape 1” parameter of each of the other identified phases, except for Li2CO3 of monoclinic structure, successively only if a sufficient number of distinct and well-defined reflections of said phases is observed.

### The Surface Area Percentage of Amorphous Phase is Determined by the Following Method:

Three samples, each of dimensions substantially equal to 50 mm×15 mm×2 mm are taken without using water, for example using a hammer, in the sample. Each sample is then stuck in a sample holder and then undergoes polishing in order to obtain a good surface condition, said polishing being carried out at the least with a 220 grade paper used with an alcohol-based lubricant, and then with the aid of diamond suspensions in a mixture of polyethylene glycol and polypropylene glycol. The surface obtained is then cleaned using pure isopropanol. The polished surface obtained is the surface which will be analyzed by Raman imaging.

Each sample is then introduced into a DXRxi Raman spectrometer sold by Thermo Scientific. The acquisition of the images and the calculation of the areas of the different phases present are performed using the software provided by the manufacturer.

The images are produced under the following conditions:
wavelength: 532 nm,
power equal to 6 mW at the sample,
diffraction grating: 1800 lines,
spectral range: 100 to 3000 cm⁻¹,
detector: EMCCD or “Electron Multiplying Charge Coupled Device” camera, with a resolution equal to 1600×200 pixels, cooled by the Peltier effect using a thermoelectric module,
exposure time: less than 10 ms,
number of passes: at least 10,
no measurement: 500 nm,
lens used: at least ×50, preferably ×100,
spatial resolution: 500 nm with linear displacement magnetic stage and high precision optical encoders.

For each of the samples, two images of dimensions 0.25 mm², preferably of dimensions 500 μm×500 μm, are produced. In total, for each product, 6 images are therefore produced.

Each image is reconstructed point by point. Each point corresponds to a Raman spectrum. Each phase, whether it be crystalline or amorphous, has a unique spectral signature. The distribution of the phases present can be visualized by assigning a color code to each phase, that is to say to each type of spectrum obtained. The crystalline phases identified in X-ray diffraction are identified first. Then, in a second step, the unattributed zones are analyzed to determine whether they consist of crystalline phases or of amorphous phases. At the end of the processing, the image obtained represents the distribution of the different crystalline and amorphous phases present. For each of the images, the amorphous phase surface area is calculated in pixels, as well as the total surface area of the image.

The percentage surface area of amorphous phase of the product is equal to the sum of the surface areas of the zones of amorphous phases of each image divided by the sum of the total surface areas of the images, expressed as a percentage.

The mean grain size was measured by the Mean Linear Intercept method. A method of this type is described in the standard ASTM E1382. According to this standard, analysis lines are plotted on images of the polycrystalline product and then, along each analysis line, the lengths, referred to as “intercepts”, between two consecutive grain boundaries intersecting said analysis line are measured.

The mean length “1′” of the intercepts “I” is then determined.

For the products of the examples, the intercepts were measured on images, obtained by scanning electron microscopy, of samples of fused polycrystalline products, said sections having been coated beforehand in a resin and polished until a mirror quality was obtained, said polishing being carried out at the least with a 220 grade paper used with an alcohol-based lubricant, and then with the aid of diamond suspensions in a mixture of polyethylene glycol and polypropylene glycol, the surface obtained then being cleaned using pure isopropanol. The magnification used for taking the images is chosen so as to visualize approximately 40 grains on one image. 5 images per polycrystalline product were produced.

The mean size “D” of the grains of a polycrystalline product is given by the relationship: D=1.56.1′. This formula is derived from formula (13) in “Average Grain Size in Polycrystalline Ceramics” M. I. Mendelson, J. Am. Ceram. Soc. Vol. 52, No.8, pp 443-446.

The roughness is measured using a Mitutoyo Surftest SJ-210, model 178-560-01D, roughness tester fitted with a 178-296 probe, used with:
a Gaussian filter,
a sampling length equal to 0.8 mm and an evaluation length equal to 4 mm when the roughness Ra is between 100 nm and 2000 nm,
a sampling length equal to 0.25 mm and an evaluation length equal to 1.25 mm when the roughness Ra is between 20 nm and 100 nm.

The air ageing is measured in the following way:

A fused LLZO membrane according to the invention and an LLZO reference membrane obtained by sintering a powder consisting of fused LLZO particles are placed in a closed polypropylene box for 6 months at ambient temperature and without humidity control.

The membranes are then examined with the naked eye to evaluate their physical integrity.

The examples that follow are provided for illustrative purposes and do not limit the invention. The fused membranes were manufactured in the following manner

The following starting raw materials were first of all intimately mixed in a mixer:
for all of the examples, a powder comprising more than 99.4% by mass of lithium carbonate Li₂CO₃, the median size of which is equal to 26 μm, and comprising trace amounts of the elements Na, Mg and Ca;
for all of the examples, a powder comprising more than 99.4% by mass of lanthanum oxide La₂O₃, the median size of which is less than 10 μm, and comprising trace amounts of the elements Y, Fe, Ca, Si and Ti;
for all of the examples, a CC10 zirconia powder sold by Société Européenne des Produits Réfractaires, comprising more than 98.5% by mass of ZrO₂ and, in trace amounts, the elements Al, Si, Na, Hf, Fe, Ca, Mg and Ti;
for example 2, a powder comprising more than 99.8% by mass of Ta₂O₅, the maximum particle size of which is less than 10 μm, and comprising, in particular in trace amounts, the elements Fe, Al, Si, Ca, Mg and Ti.

For example 1, the elements Al and/or Ca and/or Fe and/or Hf and/or Mg and/or Na and/or Si and/or Ti and/or Ta and/or Y result from the presence of these elements, in trace amounts, in the starting materials used.

For each of the examples, the starting feedstock is defined in table 1 below, in percentages by mass:

TABLE 1

| Example | Li₂CO₃ | La₂O₃ | ZrO₂ | Ta₂O₅ |
|---|---|---|---|---|
| 1 | 26 | 49.2 | 24.8 | — |
| 2 | 23.6 | 46 | 18.8 | 11.6 |

For each example, the starting feedstock, with a mass of 25 kg, was poured into a Héroult-type arc melting furnace. It was then melted at a voltage of 130 volts with an applied energy of substantially equal to 1500 kWh/T, in order to completely and homogeneously fuse the entire mixture.

When the melting was complete, the mass of molten liquid was cast in the form of a jet between two rollers with a diameter equal to 800 mm made of steel and cooled with the aid of a circulation of water such that their surface temperature was equal to 16° C., the rollers being driven in counter rotation at a speed equal to 5 rpm and spaced apart from one another by a distance equal to 2.5 mm, so as to entrain and roll the jet between said rollers. The temperature of the jet of molten liquid was between 1300° C. and 1450° C.

After passing through the rollers, plates of a thickness substantially equal to 2 mm are recovered.

Tables 2 and 3 below provide the chemical composition and the crystallographic composition of these plates. Polishing the plates as described below does not alter these results.

The surface area percentage of amorphous phase in each of the examples was measured at less than 3%.

TABLE 2

| LiₐLa_{b}Zr_{c}M_{d}O₁₂ | | | | | | | | | | | | | | | | |
|---|---|---|---|---|---|---|---|---|---|---|---|---|---|---|---|---|
| | | | | M elements | | | | | | | | | | | | |
| | Li | La | Zr | Al | Sr | Ca | Fe | Hf | Mg | Na | Si | Ti | Ta | Y | | Others |
| Ex. | a | b | c | Atomic indices | | | | | | | | | | | d | (% by mass) |
| 1 | 4.730 | 2.000 | 1.300 | 0.025 | 0.000 | 0.008 | 0.009 | 0.016 | 0.005 | 0.008 | 0.027 | 0.005 | 0.000 | 0.002 | 0.105 | <0.5 |
| 2 | 4.150 | 1.780 | 1.110 | 0.026 | 0.000 | 0.004 | 0.004 | 0.015 | 0.002 | 0.015 | 0.015 | 0.007 | 0.085 | 0.002 | 0.175 | <0.5 |

TABLE 3

| | in percentages by mass based on the mass of the crystalline phases | | |
|---|---|---|---|
| | Amount by mass of | Amount by | amount by mass of phases other |
| | cubic and tetragonal | mass of | than the oxide, hydroxide |
| | LLZO phases | cubic LLZO | and carbonate phases |
| Ex. | (%) | phase (%) | containing lithium (%) |
| 1 | 99 | 48.5 | 1 (La₂Zr₂O₇) |
| 2 | 100 | 52 | 0 |

On a plate of each example, polishing is carried out on each of the two major faces so as to obtain a fused membrane with a thickness equal to 1.5 mm and having a roughness Ra, measured on each of the two major faces, of less than 100 nm.

Reference sintered pellets were manufactured in the following manner

200 g of fused plates of each example are ground in an agate bowl with agate beads and pure acetone so as to obtain a powder having a median size equal to 9 μm. Immediately after drying in a drying oven at 50° C. for 30 minutes, said powder is broken up by hand.

Immediately after being broken up, each powder is then shaped by uniaxial pressing so as to obtain a pellet having a diameter equal to 13 mm and a mass substantially equal to 1 g under the following pressing conditions:
pressing at a pressure equal to 2 tonnes for 30 seconds,
release of the stresses for 60 seconds,
pressing at a pressure equal to 3.5 tonnes for 30 seconds,
release of the stresses for 60 seconds,
pressing at a pressure equal to 5 tonnes for 30 seconds.

Each pellet is then placed on an MgO plate, each MgO plate being placed on a bed of Li₂CO₃ powder disposed in a first alumina saggar. A second alumina saggar is then disposed upside down on the first alumina saggar. The assembly is then introduced into an electric furnace so as to sinter each pellet, under air and at atmospheric pressure, in the following thermal cycle:
rise from ambient temperature to 1185° C. at a rate equal to 100° C./h,
hold at 1150° C. for 6 hours,
descent to ambient temperature at a rate equal to 100° C./h, and then a descent at a natural rate.

Each sintered pellet obtained has a thickness equal to 1.5 mm

The stability to ageing in air of the fused membranes of examples 1 and 2 according to the invention was compared to that of the reference sintered pellets. After 6 months of storage, the fused membranes according to the invention are intact. The reference sintered pellets disintegrate greatly, that is to say lose their physical integrity, after just 15 days of storage.

This stability of the membranes according to the invention is considered to be a signature of the melting process. In other words, it reflects the fact that these membranes were obtained directly by melting.

The inventors have also observed that a membrane according to the invention having a relative skeletal density of less than 90% exhibits less ageing than a sintered reference membrane of the same relative skeletal density. In other words, and without being able to explain it in theoretical terms, for substantially identical chemistry and relative skeletal density, a fused membrane according to the invention exhibits lower air ageing than a sintered reference membrane.

The inventors have also observed that a limited variation in the relative skeletal density of the fused membranes according to the invention does not substantially alter their resistance to ageing.

As is now clearly apparent, the method according to the invention enables storage, manufacture and use of the membranes in air, which considerably reduces costs and broadens the scope of possible applications. Reduced air ageing also makes it possible to limit the resistance at the interfaces and hence to conserve a high ionic conductivity when the battery is assembled in air.

These examples also highlight the efficiency of the method according to the invention for the simple and economical industrial-scale manufacture of membranes comprising large amounts of Li₇La₃Zr₂O₁₂ phase, which is optionally doped.

The material that constitutes a membrane according to the invention is preferably the result of the solidification of a liquid mass that is entirely liquid before being cooled for solidification. The manufacturing method thereof is then very simple since it suffices to melt the starting materials, preferably in the form of powders, and then, after a bath of molten liquid has been obtained, to solidify this bath to obtain a block in the form of the membrane or from which it is possible to extract the membrane.

Of course, the present invention is not limited to the described embodiments provided by way of illustrative and nonlimiting examples.

In particular, the membranes according to the invention are not limited to particular shapes or dimensions.

1. A fused solid-state electrolyte membrane having a thickness of less than 5 mm and intended for a lithium-ion battery, the membrane consisting of a polycrystalline product comprising less than 3.0% of amorphous phase and consisting, for more than 95% of its mass, of the elements Li, La, Zr, M and O, M being a dopant chosen from the group formed by Al, P, Sb, Sc, Ti, V, Y, Nb, Hf, Ta, Se, W, Bi, Si, Ge, Ga, Sn, Cr, Fe, Zn, Na, K, Rb, Cs, Fr, Mg, Ca, Sr, Ba, lanthanides excluding La, and mixtures thereof, the contents of said elements, measured after an operation of decarbonation without loss of lithium, being defined by the formula LiₐLa_{b}Zr_{c}M_{d}O₁₂, in which the atomic indices are such that:
2.500≤a≤8.500, and
1.000≤b≤3.500, and
0.600≤c≤2.000, and
0<d≤2.000,
the membrane being a material obtained by melting a starting feedstock, in the form of a liquid mass, and then solidifying said liquid mass, the material being obtained immediately after said solidification.

2. The membrane as claimed in claim 1, wherein the total amount by mass of cubic LLZO and tetragonal LLZO phases is greater than 80.0%, in percentages by mass based on the mass of the crystalline phases, “LLZO” denoting a lithium lanthanum zirconium oxide of the generic formula Li₇La₃Zr₂O₁₂.

3. The membrane as claimed in claim 2, wherein the total amount by mass of cubic LLZO and tetragonal LLZO phases is greater than 90.0%, in percentages by mass based on the mass of the crystalline phases.

4. The membrane as claimed in claim 3, wherein the total amount by mass of cubic LLZO and tetragonal LLZO phases is greater than 99.0%, in percentages by mass based on the mass of the crystalline phases.

5. The membrane as claimed in claim 1, wherein the cubic LLZO phase represents more than 35% of all of the cubic LLZO and tetragonal LLZO phases together, in percentages by mass.

6. The membrane as claimed in claim 1, wherein, in the formula LiₐLa_{b}Zr_{c}M_{d}O₁₂,
a is greater than 2.800 and less than 8.300; and
b is greater than 1.100 and less than 3.300; and
c is greater than 0.600 and less than 1.900; and
d is greater than 0.010 and less than 1.900.

7. The membrane as claimed in claim 6, wherein
a is greater than 4.500 and less than 8.000; and
b is greater than 2.000 and less than 3.100; and
c is greater than 1.000 and less than 1.900; and
d is greater than 0.100 and less than 1.000.

8. The membrane as claimed in claim 7; wherein
a is greater than 6.000 and less than 7.000; and
b is greater than 2.500 and less than 2.900; and
c is greater than 1.400; and
d is greater than 0.200 and less than 0.400.

9. The membrane as claimed in claim 1, wherein the crystalline phases not containing lithium represent, in total, less than 3% of the mass of the crystalline phases.

10. The membrane as claimed in claim 1, comprising less than 1.0% of amorphous phase and/or having a relative skeletal density of greater than 90%, the “relative skeletal density” of a product being equal to the skeletal density of said product divided by the absolute density of said product, expressed as a percentage, the “skeletal density” being equal to the mass of said product divided by the skeletal volume that it occupies, the “skeletal volume” of the product being the sum of the volumes of the material and of the closed pores, said skeletal volume being determined on a membrane or a plate by helium pycnometry, the “absolute density” being equal to the mass of dry matter of said product after grinding to a fineness such that substantially no closed porosity remains, divided by the volume of said mass of dry matter after grinding.

11. The membrane as claimed in claim 1, having a microstructure composed for more than 90% by number of grains having an elongation factor of greater than 2.5, referred to as “elongated grains”.

12. The membrane as claimed in claim 11, wherein said elongated grains are parallel to one another.

13. The membrane as claimed in claim 1, wherein M comprises the element Y, the atomic index of element Y is greater than 0.005 and less than 0.300, and the sum of the atomic indices of elements M other than the element Y is less than 0.300.

14. The membrane as claimed in claim 13, wherein
the atomic index of element Y is less than 0.200, and the sum of the atomic indices of elements M other than the element Y is less than 0.100.

15. The membrane as claimed in claim 1, wherein
M comprises the element Ce, and the atomic index of said element Ce is less than 0.300.

16. The membrane as claimed in claim 15, wherein the atomic index of said element Ce is less than 0.200.

17. The membrane as claimed in claim 1, wherein M comprises the elements Ti and/or Fe, and the sum of the atomic indices of Ti and Fe is less than 0.800.

18. The membrane as claimed in claim 17, wherein the sum of the atomic indices of Ti and Fe is less than 0.600.

19. The membrane as claimed in claim 1, wherein
M comprises the element Al, the atomic index of element Al is greater than 0.005 and less than 1.300, and the sum of the atomic indices of elements M other than aluminum is less than 0.300.

20. The membrane as claimed in claim 19, wherein the atomic index of element Al is greater than 0.150 and less than 0.700, and the sum of the atomic indices of elements M other than aluminum is less than 0.100.

21. The membrane as claimed in claim 1, wherein
M comprises the elements Ta and/or Nb and/or V, the sum of the atomic indices of elements Ta, Nb and V is greater than 0.010 and less than 1.000, and the sum of the atomic indices of elements M other than the elements Ta, Nb and V is less than 0.300.

22. The membrane as claimed in claim 21, wherein the sum of the atomic indices of elements Ta, Nb and V is greater than 0.300 and less than 0.700, and the sum of the atomic indices of elements M other than the elements Ta, Nb and V is less than 0.100.

23. The membrane as claimed in claim 1, wherein M comprises the element Ta and the atomic index of element Ta is greater than 0.05 and less than 0.900, and the sum of the atomic indices of elements M other than the element Ta is less than 0.300.

24. The membrane as claimed in claim 1, wherein M comprises the elements Sr and/or Ba and/or Ca and/or Mg, the sum of the atomic indices of elements Sr, Ba, Ca and Mg is greater than 0.005, and the sum of the atomic indices of elements M other than the elements Sr, Ba, Ca and Mg is less than 0.300.

25. The membrane as claimed in claim 24, wherein the sum of the atomic indices of elements Sr, Ba, Ca and Mg is greater than 0.100, and the sum of the atomic indices of elements M other than the elements Sr, Ba, Ca and Mg is less than 0.100.

26. The membrane as claimed in claim 1, wherein M comprises the elements Na and/or K, the sum of the atomic indices of elements Na and K is greater than 0.005, and the sum of the atomic indices of elements M other than the elements Na and K is less than 0.300.

27. The membrane as claimed in claim 26, wherein the sum of the atomic indices of elements Na and K is greater than 0.100, and the sum of the atomic indices of elements M other than the elements Na and K is less than 0.100.

28. The membrane as claimed in claim 1, at least one of the major faces of which has a roughness Ra of less than 500 nm.

29. A lithium-ion battery comprising a membrane as claimed in claim 1, said membrane being disposed between an anode and a cathode of said battery.

30. A method for manufacturing a membrane as claimed in claim 1, said method comprising the following steps:
a) mixing starting materials so as to form a starting feedstock suitable for obtaining, on conclusion of step c), a said polycrystalline product,
b) melting the starting feedstock until a liquid mass is obtained,
c) cooling until said liquid mass has completely solidified, the cooling preferably being carried out at a rate of greater than 200° C./s,
d) polishing the polycrystalline product obtained on conclusion of step c) so as to obtain a fused membrane as claimed in any one of claims 1 to 28,
step c) comprising the following steps:
c1″) casting the liquid mass, in the form of a jet, between two rollers;
c2″) solidifying by cooling the cast liquid mass in contact with the rollers until an at least partially solidified block of polycrystalline product is obtained.
